(19) United States
(12) Patent Application Publication
(10) Pub. No.: US 2020/0110560 A1
(43) Pub. Date: Apr. 9, 2020

(54) SYSTEMS AND METHODS FOR INTERFACING WITH A NON-HUMAN ENTITY BASED ON USER INTERACTION WITH AN AUGMENTED REALITY ENVIRONMENT

(71) Applicant: Nicholas T. Hariton, Sherman Oaks, CA (US)

(72) Inventor: Nicholas T. Hariton, Sherman Oaks, CA (US)

(21) Appl. No.: 16/155,098

(22) Filed: Oct. 9, 2018

(51) Int. Cl. G06F 3/12; G06T 19/00

(52) U.S. Cl. CPC G06F 3/1206; G06F 3/04883; G06T 19/006

(57) ABSTRACT

Systems and methods for interfacing with one or more non-human entities based on user interaction with an augmented reality environment are discussed herein. A non-human entity may comprise a smart device, a software agent (such as a virtual assistant), a connected device, an Internet of Things (IoT) device, an artificial intelligence-powered device, and/or other electronic device or component configured to perform tasks or services based on user input. Based on user input related to virtual content depicted in an augmented reality environment, the systems and methods described herein may be configured to identify a non-human entity to interface with, identify actions to be executed by the non-human entity, identify information to be communicated to the non-human entity, and cause the identified information and instructions to execute the identified actions to be communicated to the non-human entity.

### FIELD OF THE INVENTION

The systems and methods described herein relate to presenting and interacting with virtual content in an augmented reality environment.

### BACKGROUND

Augmented reality environments may be used to present virtual content to users as if it were present in the real world.

### SUMMARY

The systems and methods described herein may enable a user to interface with a non-human entity based on user interaction with an augmented reality environment. An augmented reality environment may include views of images forming virtual content superimposed over views of the real world. In various implementations, the systems and methods described herein may interact with one or more non-human entities based on user interaction with an augmented reality environment. A non-human entity may comprise a smart device, a software agent (such as a virtual assistant), a connected device, an Internet of Things (IoT) device, an artificial intelligence-powered device, and/or other electronic device or component configured to perform tasks or services based on user input. For example, one or more non-human entities may comprise one or more drones and/or nanorobots (e.g., a swarm of drones or a swarm of nanorobots). Based on user input related to virtual content depicted in an augmented reality environment, the systems and methods described herein may be configured to identify one or more non-human entities to interface with, identify actions to be executed by the one or more non-human entities, identify information to be communicated to the one or more non-human entities, and cause the identified information and/or instructions to execute the identified actions to be communicated to the one or more non-human entities. In some implementations, actions to be taken by a non-human entity may directly correspond to movement by the user with respect to the augmented reality environment. For example, movement of a user's hand in the augmented reality environment may cause a corresponding movement by a non-human entity that is directly correlated with the movement of the user's hand. In some implementations, actions to be taken by a non-human entity may indirectly correspond to movement by the user with respect to the augmented reality environment.

In various implementations, the system described herein may be configured to interface with one or more non-human entities based on user interaction with an augmented reality environment, in accordance with one or more implementations. The system may include one or more of an interface, one or more physical processors, electronic storage, a display device, an imaging sensor, and/or other components.

The one or more physical processors may be configured by computer-readable instructions. Executing the computer-readable instructions may cause the one or more physical processors to interface with one or more non-human entities based on user interaction with an augmented reality environment. The computer-readable instructions may include one or more computer program components. The computer program components may include one or more of an image generation component, a display control component, a user interface component, a non-human interaction component, a communication component, and/or other computer program components. The one or more physical processors may be physically located within a user device and/or within any of the other components of the system. For example, the user device may comprise the display device and/or be communicatively coupled to the display device. The one or more physical processors may represent processing functionality of multiple components of the system operating in coordination. Therefore, the various processing functionality described in relation to the one or more processors may be performed by a single component or by multiple components of the system.

The image generation component may be configured to generate an image of virtual content to be displayed in an augmented reality environment. In various implementations, the image generation component may be configured to generate an image of virtual content to be displayed in an augmented reality environment based at least on a user's field of view and virtual content information (i.e., information defining at least the virtual content and a reference frame of the virtual content).

A user's field of view may be defined based on orientation information, location information, and/or other information. The orientation information may define an orientation of the display device. For example, the orientation of display device may be defined by one or more of a pitch angle, a roll angle, a yaw angle, and/or other measurements. When looking through the display device, the orientation of display device may indicate the direction of a user's gaze. The location information may identify a physical location of the display device. By determining the direction of a user's gaze and the user's physical position in the real world, a user's field of view may be determined.

The image generation component may be configured to automatically generate images of the virtual content as a user's field of view changes or as a living entity moves within a user's field of view, thus changing the depiction of the virtual content in the augmented reality environment based on the reference frame of the virtual content and its correlation to the position of the linkage points. As such, the virtual content may be synchronized with the position of the linkage points within the field of view of a viewing user so that the virtual content remains superimposed over the viewed user as the viewed user moves within the field of view of the viewing user.

The display control component may be configured to cause an image generated by image generation component to be displayed in an augmented reality environment via a display device. The display control component may be configured to effectuate transmission of instructions to the display device to cause the image to be displayed. Images of virtual content generated by image generation component may be presented via a display device in conjunction with the real world so that the virtual content appears as if it exists in the real world. The display control component may be configured to cause updated images of virtual content to be displayed in the augmented reality environment via a display device in real-time.

The user interface component may be configured to receive user input related to a virtual content object. For example, user input received may indicate one or more non-human entities to interact with, the virtual content involved in a non-human entity interaction, one or more actions and/or services to be performed or provided by one or more non-human entities, and/or other user input associated with a non-human entity interaction. A non-human entity interaction may comprise an interaction with a non-human entity that is based on or related to user interaction with an augmented reality environment. A given user interaction with the augmented reality environment may cause the system to communicate with one or more non-human entities, prompting the non-human entities to perform one or more actions and/or provide one or more services. User input may comprise physical input received via a user device, voice input, gesture-based input, input based on movement of the display device, input based on user eye movement, input received via a brain-computer interface (BCI), and/or one or more other types of user input. The user interface component may be configured to generate a user interface that is configured to receive user input and provide a selectable list of virtual content, non-human entities to interact with, and/or possible actions and services available via non-human entities associated with the system.

Interaction with a non-human entity may be based on user input received via one or more interface generated by the user interface component. For example, user input received may direct a non-human entity to perform one or more actions and/or provide one or more services. In an exemplary implementation in which user input prompts a non-human entity to perform one or more actions, the one or more actions may be based on the physical movement of the user input. For example, in some implementations, actions to be taken by the non-human entity may directly correspond to movement by the user with respect to the augmented reality environment. For example, movement of a user's hand in the augmented reality environment may cause a corresponding movement by a non-human entity that is directly correlated with the movement of the user's hand. In other words, movement of a user's hand when interacting with an augmented reality environment may cause a mirrored movement by a non-human entity. In some implementations, actions to be taken by the non-human entity may indirectly correspond to movement by the user with respect to the augmented reality environment. For example, movement of a user's hand in the augmented reality environment may cause a movement by a non-human entity that does not resemble the movement of the user's hand.

The non-human interaction component may be configured to identify one or more non-human entities to interact with and/or identify one or more actions to be taken by one or more non-human entities based on user input. In some implementations, a non-human entity to interact with and/or the actions to be taken may be identified based on the user input and non-human entity information maintained by the non-human interaction component. The non-human entity information may describe at least one or more capabilities of each of a set of non-human entities associated with the system. In some implementations, the non-human entity information may also specify an association between each action capable of being performed by the set of non-human entities and a set of predefined user inputs. The one or more actions to be taken by the non-human entity may be identified based on the user input, the capabilities of each of the set of non-human entities, and/or the stored association between each action capable of being performed by the set of non-human entities and the set of user inputs.

The non-human interaction component may also be configured to generate instructions for a non-human entity based on one or more identified actions. The instructions generated for the non-human entity may cause the non-human entity to perform the identified actions and/or provide one or more identified services. For example, the instructions may cause the non-human entity to perform the identified one or more actions on a real world physical object depicted in the augmented reality environment as virtual content. The instructions for a non-human entity may be generated based on communication requirements for that non-human entity. For example, non-human entity information for that non-human entity may be obtained that indicates a predefined format (e.g., a predefined machine language) that is acceptable for communicating with that non-human entity. The instructions may be generated in the predefined format for that specific non-human entity based on the non-human entity information.

The communication component may be configured to facilitate communication with one or more non-human entities. The communication component may be configured to obtain instructions generated by the non-human interaction component and cause the instructions to be transmitted to the appropriate one or more non-human entities. The instructions may include information required to interface with the one or more non-human entities and/or information that is necessary to perform the one or more actions and/or provide the one or more services. In some implementations, the communication component may be configured to receive responses back from non-human entities based on instructions provided and cause the responses to be communicated to the user.

These and other objects, features, and characteristics of the system and/or method disclosed herein, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the invention. As used in the specification and in the claims, the singular form of “a”, “an”, and “the” include plural referents unless the context clearly dictates otherwise.

### BRIEF DESCRIPTION OF THE DRAWINGS

FIG. 1 illustrates a system configured to interface with one or more non-human entities based on user interaction with an augmented reality environment, in accordance with one or more implementations.

FIG. 2A and FIG. 2B illustrate exemplary displays of an augmented reality environment, in accordance with one or more implementations.

FIG. 3A and FIG. 3B illustrate exemplary displays of an augmented reality environment, in accordance with one or more implementations.

FIG. 4 illustrates a method for interfacing with one or more non-human entities based on user interaction with an augmented reality environment, in accordance with one or more implementations.

### DETAILED DESCRIPTION

This disclosure relates to systems and methods for interfacing with one or more non-human entities based on user interaction with an augmented reality environment, in accordance with one or more implementations. A non-human entity may comprise a smart device, a software agent (such as a virtual assistant), a connected device, an Internet of Things (IoT) device, an artificial intelligence-powered device, and/or other electronic device or component configured to perform tasks or services based on user input. Based on user input related to virtual content depicted in an augmented reality environment, the systems and methods described herein may be configured to identify one or more non-human entities to interface with, identify actions to be executed by the one or more non-human entities, identify information to be communicated to the one or more non-human entities, and cause the identified information and instructions to execute the identified actions to be communicated to the one or more non-human entities.

It will be appreciated by those having skill in the art that the implementations described herein may be practiced without these specific details or with an equivalent arrangement. In other instances, well-known structures and devices are shown in block diagram form in order to avoid unnecessarily obscuring the implementations of the invention.

Exemplary System Architecture

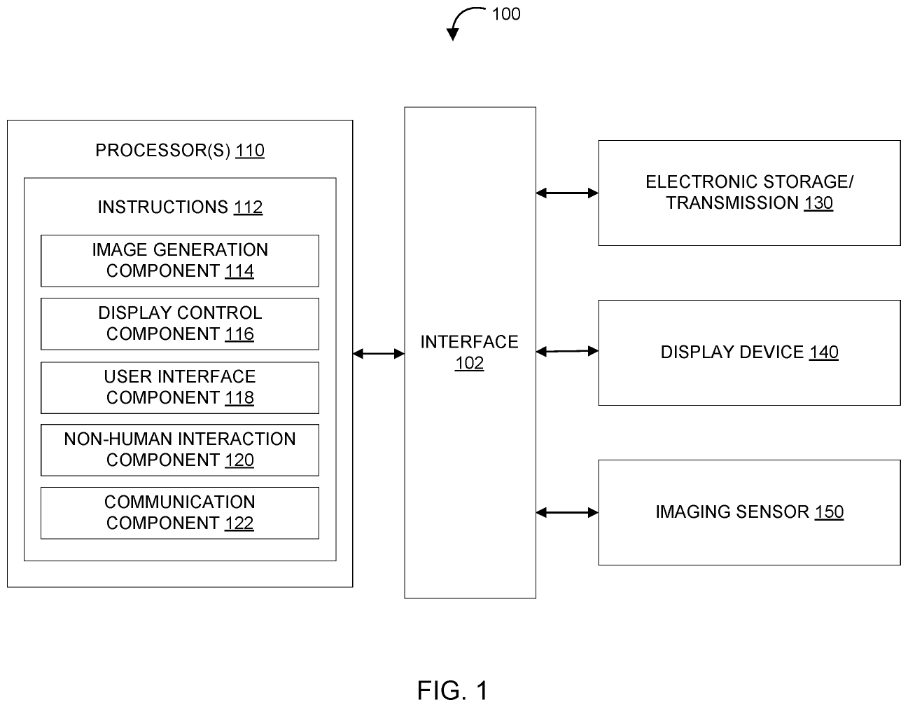

FIG. 1 illustrates a system 100 for interfacing with one or more non-human entities based on user interaction with an augmented reality environment, in accordance with one or more implementations. The system may include one or more of interface 102, one or more physical processors 110, electronic storage 130, display device 140, imaging sensor 150, and/or other components.

The one or more physical processors 110 (also interchangeably referred to herein as processor(s) 110, processor 110, or processors 110 for convenience) may be configured to provide information processing capabilities in system 100. As such, the processor(s) 110 may comprise one or more of a digital processor, an analog processor, a digital circuit designed to process information, a central processing unit, a graphics processing unit, a microcontroller, an analog circuit designed to process information, a state machine, and/or other mechanisms for electronically processing information.

Processor(s) 110 may be configured to execute one or more computer readable instructions 112. Computer readable instructions 112 may include one or more computer program components. Computer readable instructions 112 may include one or more of image generation component 114, display control component 116, user interface component 118, non-human interaction component 120, communication component 122, and/or other computer program components. As used herein, for convenience, the various computer readable instructions 112 will be described as performing an operation, when, in fact, the various instructions program the processor(s) 110 (and therefore system 100) to perform the operation.

Image generation component 114 may be configured to generate an image of a virtual content object to be displayed in an augmented reality environment. As used herein, the term “augmented reality environment” may refer to a simulated environment that includes the visual synthesis and/or combination of both (i) visible physical objects and/or physical surroundings, and (ii) visual virtual content presented in conjunction with the visible physical objects and/or physical surroundings to visually augment the visible physical objects and/or physical surroundings. The visual virtual content to be presented within a given physical environment (e.g., the visible physical objects and/or physical surroundings at a given location) may be referred to as a “virtual environment”. In some implementations, virtual content may be superimposed over a physical object (or objects) to replace such physical object(s) in the augmented environment. Descriptions herein (such as the forgoing) describing visual augmentation of a physical environment within an augmented reality environment should not be read as precluding other forms of augmentation (e.g., audio, haptic, etc.).

In various implementations, image generation component 114 may be configured to generate an image of virtual content to be displayed in an augmented reality environment visible via display device 140. Images of virtual content generated by image generation component 114 may be presented via a display of display device 140 in conjunction with the real world so that the virtual content appears as if it exists in the real world. In various implementations, image generation component 114 may be configured to generate an image of virtual content to be displayed in an augmented reality environment based at least on a user's field of view and virtual content information. In some implementations, image generation component 114 may be configured to generate images of multiple virtual content items or sets of virtual content to be displayed in the augmented reality environment simultaneously. For example, a first virtual content item based on a first reference frame may be depicted simultaneously with a second virtual content item based on a second reference frame. The techniques described herein may be used to generate an image of any virtual content to be displayed in an augmented reality environment.

In some implementations, virtual content depicted in the augmented reality environment may comprise a set of virtual content. A set of virtual content is one or more virtual content items that share a reference frame. That is, the position, orientation, scale, and/or other parameters of the virtual content item or items in the set of virtual content can be manipulated in a coordinated way by manipulating the reference frame for the set of virtual content. In various implementations, image generation component 114 may be configured to generate one image and/or a set of images comprising a set of virtual content to be displayed in an augmented reality environment.

In various implementations, image generation component 114 may be configured to generate an image of virtual content to be displayed in an augmented reality environment based on virtual content information. Virtual content information may define virtual content (or a set of virtual content), a reference frame of the virtual content, and/or a correlation between linkage points and the reference frame of the virtual content. Linkage points may be defined with respect to a user in the real world. The linkage points may serve as an anchor for the reference frame of the virtual content. As such, when rendered in an augmented reality environment by display device 140, the virtual content may appear within a user's field of view based on how the reference frame of the virtual content is correlated to the real world by virtue of the position of the linkage points in the real world.

In various implementations, image generation component 114 may be configured to generate an image of virtual content to be displayed in an augmented reality environment based on a user's field of view. When utilizing display device 140, a display of the display device may contain a view of the real world based on the user's field of view. A user's field of view may be defined based on orientation information, location information, and/or other information. For example, a user's field of view may be defined based at least on orientation information associated with display device 140 and location information associated with display device 140. Orientation information may define an orientation of display device 140. In some implementations, the orientation of display device 140 may refer to one or more of a pitch angle, a roll angle, a yaw angle, and/or other measurements. Orientation information may be obtained from an orientation sensor of display device 140. When looking through display device 140, the orientation of display device 140 may indicate the direction of a user's gaze. In some implementations, one or more eye tracking techniques now known or future developed may be used to determine the direction of gaze of a user. For example, display device 140 may capture the images of a user within a display device and extract a position of the user's eyes. The position of the user's eyes may be used to determine a more precise indication of the direction of the user's gaze. Location information may identify a physical location of display device 140. In some implementations, the physical location of display device 140 may refer to the geographic location of display device 140. Location information may identify a physical location based on GPS coordinates, an address, a relative position with respect to one or more identified locations, one or more sign posts, and/or other information. Location information may be obtained from a GPS component of a user device, display device 140, and/or other component of system 100. By determining the direction of a user's gaze and the user's physical position in the real world, a user's field of view may be determined.

In various implementations, image generation component 114 may be configured to generate a new image of virtual content as a user's field of view changes. For example, display device 140 may move as a user utilizing display device 140 changes position and/or rotates display device 140. As display device 140 moves, image generation component 114 may be configured to automatically generate a new image based on the user's current field of view and virtual content information for the virtual content depicted. Therefore, image generation component 114 may be configured to generate a new image of virtual content based at least on a user's current field of view in real-time. In various implementations, image generation component 114 may be configured to obtain an indication of an updated position of display device 140 in the real world at a second time and generate an updated image of virtual content based on the updated position of the display device 140 at the second time and the user's field of view at the second time. Therefore, image generation component 114 may be configured to generate a first image of virtual content to be displayed at a first time based on the field of view of the user at the first time and generate a second image of virtual content to be displayed at a second time based on the field of view of the user at the second time.

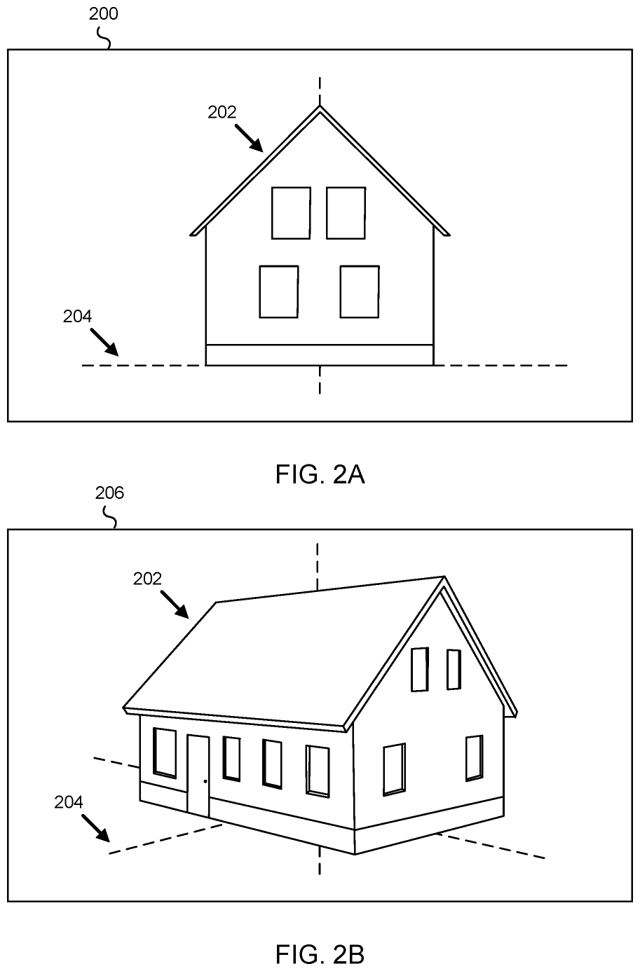

For example, and referring to FIG. 2A, exemplary display 200 of an augmented reality environment is illustrated, in accordance with one or more implementations. Exemplary display 200 may comprise an image of virtual content 202 comprising a house. In some implementations, virtual content 202 may be anchored to a marker comprising one or more linkage points. In this exemplary embodiment, the marker may comprise or be defined based on a physical object such as a house or building, a smartphone, and/or some other real-world object visible within a user's field of view via display device 140. In various implementations, an image of virtual content 202 may be generated based on virtual content information defining the virtual content and a correlation between the marker and reference frame 204 of virtual content 202. As display device 140 moves, image generation component 114 may be configured to automatically generate a new image based on the user's current field of view. For example, and referring to FIG. 2B, exemplary display 206 of an augmented reality environment with virtual content is illustrated, in accordance with one or more implementations. As a user (or display device 140) moves with respect to a marker and reference frame 204, the images presented to the user via display device 140 may change based on the change in the user's field of view. For example, exemplary display 206 may comprise a display of the augmented reality environment depicted in exemplary display 200 after a user (or display device 140) moves rotationally around a marker and reference frame 204. As such, exemplary display 206 may comprise an image of virtual content 202 at a different vantage point (i.e., from a different angle and/or position). In various implementations, reference frame 204 may be anchored to one or more linkage points of a marker, enabling virtual content 202 to be fixed in space as a user (or display device 140) moves with respect to the marker, reference frame 204, and, accordingly, the image of virtual content 202.

In various implementations, image generation component 114 may be configured to generate exterior images and/or interior images of virtual content. Virtual content information may define exterior images and/or interior images of virtual content visible via display device 140 based on the position of display device 140 with respect to a reference frame of virtual content. In other words, as a user moves with respect to a reference frame of virtual content, image generation component 114 may be configured to generate images of the virtual content object to give the user the impression the user is walking through the virtual content object. In some implementations, the size of the image of a virtual content object in the augmented reality environment may be the same as, similar to, or proportionate to the size of the object depicted by the virtual content object as it appears, or would appear, in the real world. Thus, in some implementations, image generation component 114 may be configured to depict virtual content objects in an augmented reality environment as they appear, or would appear, in the real world, enabling users to perceive and interact with (e.g., walk through) the virtual content objects as they exist or would exist in the real world. In some implementations, the image of a virtual content object may appear much larger or much smaller in the augmented reality environment than how the object depicted by the virtual content object appears, or would appear, in the real world. In other words, a virtual content object depicting a particular object may be depicted in the augmented reality environment at any size that is suitable and/or desirable for viewing the object in the augmented reality environment. In an exemplary implementation in which a virtual content object comprises a three-dimensional virtual image of a nano construction or a graphene mesh, the virtual content object may be depicted in an augmented reality environment much larger than it appears or would appear in the real world, enabling a user to perceive and/or interact with an image of the nano construction or graphene mesh without the use of a microscope. In an exemplary implementation in which a virtual content object comprises a ship, the virtual content object may be depicted in an augmented reality environment much smaller than it appears or would appear in the real world, enabling a user to perceive and interact with multiple sides of the ship simultaneously via the image of the ship.

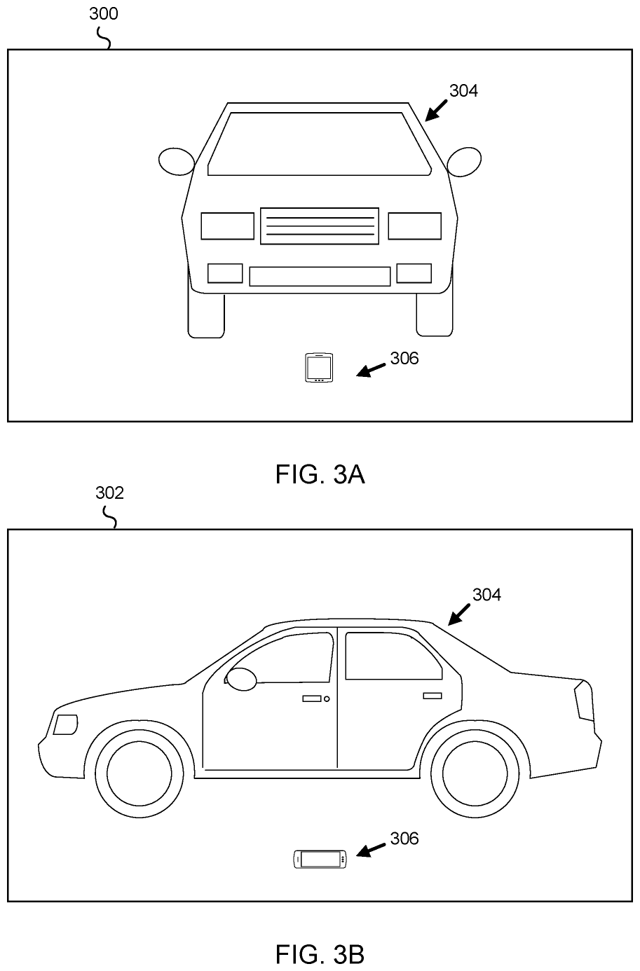

Referring to FIG. 3A, exemplary display 300 of an augmented reality environment with virtual content is illustrated, in accordance with one or more implementations. Exemplary display 300 may comprise marker 306 and an image of virtual content 304. Exemplary display 300 may include virtual content 304 depicting an automobile. Marker 306 may comprise or be defined based on an association with a smart phone. Marker 306 may be associated with multiple linkage points that serve as an anchor for the reference frame of virtual content 304. In various implementations, virtual content information defining virtual content 304 and/or a correlation between the linkage points and a reference frame of virtual content 304 may be obtained from marker 306. As display device 140 moves, image generation component 114 may be configured to automatically generate a new image based on the user's current field of view. For example, and referring to FIG. 3B, exemplary display 302 of an augmented reality environment with virtual content is illustrated, in accordance with one or more implementations. As one or more users (or one or more display devices, such as display device 140) move with respect to marker 306, the images presented to each user via the user's display device (such as display device 140) may change based on the change in each user's field of view. For example, exemplary display 302 may comprise a display of the augmented reality environment depicted in exemplary display 300 after a user (or display device 140) moves 90 degrees rotationally around marker 306. As such, exemplary display 302 may comprise an image of virtual content 304 rotated 90 degrees.

In an exemplary implementation, image generation component 114 may be configured to generate an exterior image and/or interior image of virtual content 304 based on the position of display device 140 with respect to a reference frame of virtual content 304 and/or the position of display device 140 with respect to marker 306. As such, a user may visualize both the exterior and interior of a car (virtual content 304) in an augmented reality environment via display device 140. In an exemplary implementation, a user may choose features of a new car and build a custom virtual content object to visualize the car. Each of the features of the new car may comprise or be defined by one or more parameters of the virtual content object. In an exemplary implementation in which the virtual content object depicts a historical building or a historical monument, image generation component 114 may be configured to automatically generate images of the virtual content as a user's field of view changes, thus enabling a user to visualize a historical building such as the Pantheon or a historical monument such as Stonehenge from multiple angles or from the exterior or interior, all within in an augmented reality environment.

In various implementations, image generation component 114 may be configured to generate an image of virtual content to be displayed in an augmented reality environment based on virtual content information obtained from electronic storage (e.g., electronic storage 130) and/or via a network. For example, virtual content information may be obtained via the Internet, cloud storage, and/or one or more other networks. In some implementations, virtual content information may be obtained from one or more connected devices (e.g., a device of another user visible within a field of view of the user). For example, virtual content information may be received from one or more connected devices (e.g., a device of another user visible within a field of view of the user) responsive to a request for the virtual content information from the user (i.e., a request received via one or more devices of the user).

In some implementations, virtual content information may be obtained from a sign post (or smart marker such as marker 306). For example, image generation component 114 may be configured to generate an image of virtual content to be displayed in an augmented reality environment based on virtual content information obtained from a sign post as described in co-pending U.S. patent application Ser. No. 15/707,854, entitled “SYSTEMS AND METHODS FOR UTILIZING A DEVICE AS A MARKER FOR AUGMENTED REALITY CONTENT,” Attorney Docket No. 57YG-261775, the disclosure of which is hereby incorporated by reference in its entirety herein.

In various implementations, virtual content depicted in an augmented reality environment may comprise a virtual content object. Virtual content objects are three-dimensional virtual images of objects, such as three-dimensional virtual images of constructed objects. For example, the objects may comprise buildings, houses, machines, vehicles, components of larger objects, and/or other three-dimensional objects. In various implementations, the objects may represent objects that may or may not exist in the real-world. In various implementations, the objects may represent objects that are within a field of view of a user or are remote from the user. For example, image generation component 114 may be configured to generate an image of a virtual content object that, when depicted in an augmented reality environment, comprises a virtual representation of a real world physical object that is remote from a user. In some implementations, virtual content depicted in an augmented reality environment may comprise an augmented rendering of a user or other living entity. An augmented rendering of a user or other living entity may comprise a full- or partial-body virtual content item depicted based on that user or living entity, or one or more other users or living entities. For example, a user or living entity for which virtual content may be depicted may be human and/or of one or more other species (e.g., a dog, a cat, and/or one or more other species).

In some implementations, image generation component 114 may be configured to generate an image of virtual content to be displayed in an augmented reality environment based on virtual content information generated by one or more non-human entities. For example, a non-human entity may be configured to generate virtual content information defining virtual content that may be displayed in the augmented reality environment. In some implementations, virtual content information may be generated by non-human entities equipped with 3D cameras and/or one or more other sensors to generate a virtual content object in real-time that may be viewed and interacted with by a user (e.g., to explore, diagnose emergencies, formulate and/or test possible solutions, make repairs, and/or provide feedback related to ongoing construction). In some implementations, virtual content information may be generated and/or modified by one or more non-human entities based on user inputs comprising a request to modify existing virtual content. Image generation component 114 may be configured to obtain virtual content information from non-human entities and generate an image of virtual content to be displayed in an augmented reality environment based on the virtual content information obtained from the non-human entity.

In various implementations, image generation component 114 may be configured to generate images of virtual content to be displayed in an augmented reality environment and/or facilitate interaction with virtual content displayed in an augmented reality environment using some or all of the techniques described herein. In some implementations, image generation component 114 may be configured to generate images of virtual content to be displayed in the augmented reality environment and/or facilitate interaction with virtual content displayed in an augmented reality environment using some or all of the techniques described herein and/or one or more techniques described in co-pending U.S. patent application Ser. No. 15/796,716, entitled “SYSTEMS AND METHODS FOR RENDERING A VIRTUAL CONTENT OBJECT IN AN AUGMENTED REALITY ENVIRONMENT,” Attorney Docket No. 57YG-261776, co-pending U.S. patent application Ser. No. 15/893,498, entitled “SYSTEMS AND METHODS FOR UTILIZING A LIVING ENTITY AS A MARKER FOR AUGMENTED REALITY CONTENT,” Attorney Docket No. 57YG-261777, and co-pending U.S. patent application Ser. No. 15/965,689, entitled “SYSTEMS AND METHODS FOR GENERATING AND FACILITATING ACCESS TO A PERSONALIZED AUGMENTED RENDERING OF A USER,” Attorney Docket No. 57YG-261778, the disclosures of which are hereby incorporated by reference in their entirety herein.

Display control component 116 may be configured to cause an image of virtual content to be displayed in an augmented reality environment via display device 140. In various implementations, display control component 116 may be configured to effectuate transmission of instructions to display device 140. Images of virtual content generated by image generation component may be presented via a display device in conjunction with the real world so that the virtual content appears as if it exists in the real world.

In various implementations, display control component 116 may be configured to generate and/or obtain instructions causing an image of virtual content to be displayed via display device 140. In some implementations, display control component 116 may be configured to cause updated images of virtual content to be displayed in the augmented reality environment via a display device in real-time. In some implementations, display control component 116 may be configured to cause images of multiple virtual content items or multiple sets of virtual content to be displayed in an augmented reality environment simultaneously via display device 140.

User interface component 118 may be configured to receive user input related to virtual content depicted in an augmented reality environment. User input may comprise physical input received via a user device, voice input, gesture-based input, input based on movement of the display device, input based on user eye movement, input received via a brain-computer interface (BCI), and/or one or more other types of user input. For example, user input may comprise physical input received via a user interface generated by user interface component 118. A brain-computer interface (BCI) comprises a communication pathway between the brain and an external device and is sometimes referred to as a neural-control interface (NCI), a mind-machine interface (MMI), a direct neural interface (DNI), or a brain-machine interface (BMI). In some implementations, the user input may be received via a user device (e.g., via a user interface provided by user interface component 118), display device 140, and/or other device connected to system 100. In some implementations, the user input may be provided to system 100 via a user device, display device 140, and/or other device connected to system 100. In various implementations, user input received via user interface component 118 may comprise user input related to virtual content displayed in an augmented reality environment.

In various implementations, user interface component 118 may be configured to generate and cause a user interface to be displayed to a user. In various implementations, the user interface may be displayed to a user via a display interface of a user device. For example, a user interface may be displayed to a user via a graphical user interface of a user device, a display of display device 140, a display of a smartphone, or any other display interface provided via a user device and/or a component of system 100.

In various implementations, user interface component 118 may be configured to generate a user interface that provides a user with information related to system 100. For example, the information related to the system may comprise an indication of one or more connected devices (e.g., a user device such as a smartphone or display device, and/or other devices connectable to system 100); virtual content depicted in the augmented reality environment whether currently visible or not; virtual content available to be presented via display device 140 (e.g., content available via one or more devices of a user, electronic storage 130, and/or other components of system 100); an indication of a direction in which virtual content may be visible via display device 140 (e.g., one or more arrows depicted a direction to move the display device to visualize virtual content); an indication of one or more markers or linkage points visible via display device 140; an indication of one or more users, living entities, and/or recognizable objects visible via display device 140; one or more instructions for the user to trigger the rendering of virtual content in the augmented reality environment via display device 140; an indication of one or more other users interacting with and/or viewing virtual content; a current time and/or date, and/or other information related to system 100. In some implementations, user interface component 118 may be configured to generate a user interface that provides a user with information related to the physical object, location, or biological entity(s) depicted in an augmented reality environment. In some implementations, user interface component 118 may be configured to generate a user interface that provides a user visualizing an augmented reality environment with information related to system 100 without enabling that user to provide input via the user interface.

In an exemplary implementation, information provided via a user interface may comprise information related to a real-world environment being monitored by a user by controlling a non-human entity present in the real-world environment through interaction with an augmented reality environment. For example, a non-human entity may comprise a smart device and/or other device configured to monitor a real-world environment such as a detention center or medical facility. In an exemplary implementation, a non-human entity may be configured to provide a physical presence in a real-world environment (e.g., at a detention center or medical facility) that enables a remote user to interact with individuals in the real-world environment (e.g., prisoners in the detention center or patients in the medical facility), capture phones and/or videos of the real-world environment via cameras affixed to or communicatively coupled to the non-human entity, and/or otherwise perform actions or provide services in the real-world environment based on interaction by the remote user with an augmented reality environment visible to the remote user.

In various implementations, user interface component 118 may be configured to generate a user interface that provides a user with information related to system 100 and enables a user to provide input. For example, the user interface may comprise selectable icons, input fields, and/or other user input options enabling a user to control one or more aspects of system 100. In some implementations, user interface component 118 may be configured to generate a user interface that enables a user to request virtual content to be rendered in the augmented reality environment. In some implementations, user interface component 118 may be configured to generate a user interface that enables a user to modify virtual content information for virtual content based on one or more types of user input. In some implementations, user interface component 118 may be configured to cause a selectable list of virtual content to be provided to a user via a user interface. For example, the selectable list of virtual content may comprise virtual content available to be displayed (but not already displayed) in the augmented reality environment and/or virtual content currently displayed in the augmented reality environment. In some implementations, user interface component 118 may be configured to receive a selection indicating virtual content to be presented via display device 140. For example, user interface component 118 may be configured to receive user input indicating a selection of one or more virtual content items to be presented via display device 140. In some implementations, user interface component 118 may be configured to cause a selectable list of non-human entities available to interact with to be provided to a user via a user interface. For example, a user interface may be provided that comprises a selectable list of each of the non-human entities associated with system 100 that a user may interact with based on user interaction with an augmented reality environment at a given time. In some implementations, user interface component 118 may be configured to receive a selection indicating one or more non-human entities to interact with. For example, user interface component 118 may be configured to receive user input indicating a selection of one or more non-human entities to interact with based on the user input received and/or one or more subsequent user inputs received. In some implementations, user interface component 118 may be configured to cause a selectable list of the one or more possible actions and/or services available to be provided by non-human entities associated with system 100. For example, in an exemplary implementation in which the non-human entities associated with system 100 include one or more drones, the one or more selectable controls may enable a user to choose to direct the actions of one or more individual drones and/or a swarm of drones.

In various implementations, user input received may be related to specific virtual content depicted in an augmented reality environment. For example, a user may select and interact with a single virtual content item or object displayed in an augmented reality environment. The virtual content item or object a user is currently interacting with, or most recently interacted with, may comprise an activated virtual content item or object. In some implementations, a user may interact with multiple virtual content items or objects simultaneously.

In various implementations, non-human interaction based on user interaction with an augmented reality environment may be related to all or a portion of an augmented reality environment. In some implementations, non-human interaction based on user interaction with an augmented reality environment may be related to one or multiple virtual content items or objects depicted in an augmented reality environment. In other words, non-human interaction may involve a single virtual content item or object, multiple virtual content items or objects (or a set of virtual content items or objects), one or more human or non-human users (e.g., one or more different biological entities), the augmented reality environment currently visualized by a user, and/or the entirety of an augmented reality environment.

In various implementations, user input received may indicate one or more virtual content items or objects to interact with. For example, a user may select a virtual content item by pointing to the virtual content item in the augmented reality environment, calling out the name of the virtual content item, selecting the virtual content item from a list of virtual content items currently displayed in the augmented reality environment, and/or otherwise indicating that the user wishes to select that particular virtual content. In some implementations, user input received may be applied to selected virtual content. For example, when requests to modify virtual content are received, the request to modify the virtual content may be associated with virtual content that is activated and/or selected prior to receiving the request to modify. In some implementations, user input may be automatically applied to activate virtual content until other virtual content is activated. In some implementations, user interface component 118 may automatically identify virtual content to associate with user input. For example, user interface component 118 may automatically identify the virtual content to associate with user input based on a proximity of the virtual content to the user input. For example, user interface component 118 may automatically associate the closest virtual content to user input received with the user input. In some implementations, user interface component 118 may automatically identify virtual content to associate with user input based on the user input and virtual content information defining the virtual content. For example, virtual content information defining virtual content may indicate one or more possible actions and/or services that may be applied to the virtual content, user input that may prompt one or more possible actions and/or services with the virtual content, and/or other stored correlations that may cause user input to be associated with the virtual content.

In various implementations, the user input received may comprise a request to modify virtual content. For example, the user input may comprise a request to modify a single virtual content item or object and/or a request to modify a set of virtual content. A request to modify virtual content may comprise a request to modify one or more parameters of the virtual content. Modifying the parameters may alter the appearance (e.g., the size, shape, orientation, and/or dimensions of the virtual content), movements, animation, tactile feedback, and/or other aspects of the virtual content. For example, modifications to a virtual content object may include modifications related to the size of the virtual content object. Modifications to virtual content may include modifications to any number of specific aspects of the virtual content. For example, in an exemplary implementation in which a three-dimensional representation of a user is displayed in an augmented reality environment, user input comprising a request to modify the three-dimensional representation may comprise a request to modify muscle tone, curviness, skin tone or other coloring (e.g., blushing), body proportions, and/or other aspects of a three-dimensional representation.

In various implementations, user interface component 118 may be configured to receive user input related to a non-human entity interaction. For example, user input received may indicate one or more non-human entities to interact with, virtual content (to be) involved in the non-human entity interaction, one or more actions and/or services to be executed by the one or more non-human entities, and/or other user input associated with the non-human entity interaction. A non-human entity interaction may comprise an interaction with one or more non-human entities that is based on or related to user interaction with an augmented reality environment. A given user interaction with the augmented reality environment may cause the system to communicate with one or more non-human entities, prompting the one or more non-human entities to perform one or more actions and/or provide one or more services.

In various implementations, interaction with one or more non-human entities may be based on user input received via user interface component 118. For example, user input received may direct a non-human entity to perform one or more actions and/or provide one or more services. In an exemplary implementation in which user input prompts a non-human entity to perform one or more actions, the one or more actions may be based on the physical movement of the user input. For example, in some implementations, actions to be taken by the non-human entity may directly correspond to movement by the user with respect to the augmented reality environment. For example, movement of a user's hand in the augmented reality environment may cause a corresponding movement by a non-human entity that is directly correlated with the movement of the user's hand. In other words, movement of a user's hand when interacting with an augmented reality environment may cause a mirrored movement by a non-human entity. In some implementations, actions to be taken by the non-human entity may indirectly correspond to movement by the user with respect to the augmented reality environment. For example, movement of a user's hand in the augmented reality environment may cause a movement by a non-human entity that does not resemble the movement of the user's hand.

Non-human interaction component 120 may be configured to facilitate interaction with one or more non-human entities based on user input related to virtual content displayed in an augmented reality environment. In various implementations, non-human interaction component 120 may be configured to facilitate interaction related to virtual content involving one or more users and a non-human user (e.g., via a robot interface). For example, interaction with virtual content by one or more users and a non-human entity may include bi-directional artificial intelligence communication. The communication may be provided through a virtual or real character. For example, a virtual character may comprise a virtual assistant (e.g. Siri, Alexa, Watson, and/or one or more other virtual assistants) where communication may be output through a speaker of a user device, display device 140, and/or other component of system 100, and/or on a screen of a user device, display device 140, and/or other component of system 100. A real character may be in the form of a robot. In various implementations, non-human interaction component 120 may be configured to generate and transmit instructions in the appropriate machine language, as described herein.

In some implementations, one or more users may interact with the same virtual content and/or interface with the same one or more non-human entities. For example, in some implementations, system 100 may be configured to facilitate remote interaction with virtual content depicted in the augmented reality environment by one or more other users and/or one or more non-human entities. In some implementations, system 100 and/or computer readable instructions 112 may include a content management component and/or a remote interaction component. At least the remote interaction component may be configured to facilitate numerous types of remote interaction with virtual content. For example, to facilitate remote interaction with virtual content and/or one or more non-human entities, system 100 and/or computer readable instructions 112 may further include a content management component and/or a remote interaction component as described in co-pending U.S. patent application Ser. No. 15/796,716, entitled “SYSTEMS AND METHODS FOR RENDERING A VIRTUAL CONTENT OBJECT IN AN AUGMENTED REALITY ENVIRONMENT,” Attorney Docket No. 57YG-261776, the disclosure of which is hereby incorporated by reference in its entirety.

A non-human entity may comprise a smart device, a software agent (such as a virtual assistant), a connected device, an Internet of Things (IoT) device, an artificial intelligence-powered device, and/or other electronic device or component configured to perform tasks or services based on user input. For example, a smart device may comprise a 3-D printer and an artificial intelligence-powered device may comprise a robot. In various implementations, non-human interaction component 120 may be configured to identify one or more non-human entities to interface with. For example, non-human interaction component 120 may be configured to identify a non-human entity to interface with based on user input received and/or non-human entity information. In various implementations, non-human interaction component 120 may be configured to identify one or more actions to be executed by the non-human entity and/or information to be communicated to the non-human entity to enable the non-human entity to execute the one or more actions.

In various implementations, non-human interaction component 120 may be configured to maintain information related to a set of non-human entities. For example, non-human interaction component 120 may be configured to maintain non-human entity information. In some implementations, non-human interaction component 120 may be configured to cause non-human entity information to be stored electronically. For example, non-human interaction component 120 may be configured to cause non-human entity information to be stored in electronic storage (e.g., electronic storage 130). In some implementations, electronic storage 130 may be configured to store non-human entity information for each non-human entity associated with system 100.

Non-human entity information may comprise information indicating capabilities, accessibility, user preferences, interaction history, communication requirements, and/or other information related to a non-human entity. Information indicating and/or describing capabilities may comprise information defining one or more actions and/or services able to be provided by a non-human entity. For example, information indicating capabilities of a non-human entity may indicate an association between one or more actions and/or services capable of being performed by the non-human entity and a set of predefined user inputs. Information indicating accessibility (or accessibility information) may describe when, how, and under what conditions a non-human entity may be accessed via non-human interaction component 120 based on user interaction with an augmented reality environment. For example, a non-human entity may only be available at predefined time periods, when a user (or display device 140 of the user) is in a predefined geographic location, when interacting with predefined virtual content or virtual content satisfying one or more predefined requirements, and/or other instances specified by the accessibility information for a non-human entity. Information indicating user preferences may comprise user preferences related to individual non-human entities and/or actions or services to be performed by an individual non-human entity. Information indicating user interaction history may comprise a record of prior user interactions with one or more non-human entities and the one or more actions and/or services performed by the non-human entities. Information indicating communication requirements may comprise an indication of a predefined format that is acceptable for communicating with a non-human entity. For example, the information indicating communication requirements for a non-human entity may specify the appropriate machine language for communication with the non-human entity.

In various implementations, non-human interaction component 120 may be configured to identify one or more non-human entities to interact with based on user input received and/or non-human entity information. Responsive to the receipt of user input, non-human interaction component 120 may be configured to identify at least one non-human entity from the set of non-human entities associated with system 100 to transmit instructions. In some implementations, non-human interaction component 120 may be configured to identify a non-human entity to interact with based solely on user input. In an exemplary implementation, a selectable list of non-human entities may be provided to a user via a user interface (e.g., a user interface generated by user interface component 118). In some implementations, non-human interaction component 120 may be configured to identify a non-human entity to interact with based on user input comprising a selection of the non-human entity (e.g., user input comprising a selection of a non-human entity on a selectable list of non-human entities provided via a user interface).

In various implementations, non-human interaction component 120 may be configured to identify one or more non-human entities to interact with based on user input received and non-human entity information. In various implementations, non-human interaction component 120 may be configured to obtain non-human entity information in response to receiving user input. For example, non-human interaction component 120 may be configured to obtain non-human entity information from electronic storage 130 in response to receipt of user input via user interface component 118. In various implementations, non-human interaction component 120 may be configured to compare user input received with non-human entity information for one or more non-human entities associated with system 100. Based on the comparison of user input received and the non-human entity information for one or more non-human entities, non-human interaction component 120 may be configured to identify a non-human entity to interact with. In some implementations, non-human interaction component 120 may be configured to maintain a map of the capabilities of the one or more non-human entities associated with system 100. For example, the map of capabilities may indicate the actions and/or services able to be performed by non-human entities associated with system 100 and which non-human entities are able to perform the specified actions and/or services. In some implementations, non-human interaction component 120 may be configured to compare user input indicating an action or request to be performed by a non-human entity to the map of capabilities to determine a non-human entity to perform the action or request.

In some implementations, non-human interaction component 120 may be configured to identify one or more non-human entities to interact with based on accessibility information for one or more non-human entities associated with system 100. For example, accessibility information for a non-human entity may indicate when, how, and under what conditions a non-human entity may be accessed via non-human interaction component 120 based on user interaction with an augmented reality environment. In an exemplary implementation in which user input related to a virtual content object is received that prompts an action or service by a non-human entity, non-human interaction component 120 may be configured to identify a non-human entity to interact with based on the user input and the accessibility information. For example, the accessibility information for a given non-human entity may indicate that the non-human entity is unavailable to perform the action or service because the user input was received outside (or inside) a predefined time period, the user has used up its allotted time or number of interactions (in a given time period or for a given subscription level) with that non-human entity, the user input was received outside (or inside) a predefined geographic location, and/or the virtual content related to the action or service does not satisfy one or more predefined requirements. Accordingly, non-human interaction component 120 may be configured to not generate instructions for that non-human entity to perform the action or service, and may instead identify one or more other non-human entities to perform the action or service.

In various implementations, non-human interaction component 120 may be configured to identify one or more actions and/or services to be taken or provided by one or more non-human entities based on user input received. For example, non-human interaction component 120 may be configured to determine one or more actions to be taken and/or services to be provided by the non-human entity identified based on user input received. In some implementations, non-human interaction component 120 may be configured to identify one or more actions to be taken and/or services to be provided by a non-human entity based solely on user input. In an exemplary implementation, a selectable list of actions and/or services may be provided to a user via a user interface (e.g., a user interface generated by user interface component 118). In some implementations, non-human interaction component 120 may be configured to identify one or more actions to be taken and/or services to be provided by a non-human entity based on user input comprising a selection of the one or more actions and/or services (e.g., user input comprising a selection of one or more actions and/or services on a selectable list of actions and/or services provided via a user interface).

In various implementations, non-human interaction component 120 may be configured to identify one or more actions to be taken and/or services to be provided by one or more non-human entities based on user input received and non-human entity information. In various implementations, non-human interaction component 120 may be configured to compare user input received with non-human entity information for one or more non-human entities associated with system 100. Based on the comparison of user input received and the non-human entity information for one or more non-human entities, non-human interaction component 120 may be configured to identify one or more actions to be taken and/or services to be provided by a non-human entity.

The actions or services that may be executed or provided may comprise any number of actions or services that may be executed or provided by one or more non-human entities. For example, actions or services that may be executed or performed by a non-human entity based on user interaction with an augmented reality environment include modifying virtual content displayed in an augmented reality environment; generating virtual content information for virtual content to be displayed in an augmented reality environment; modifying a real world object or entity based on user interaction with virtual content corresponding to the real world object or entity; generating or constructing a real world object based on virtual content; generating or building a graphene mesh; generating or updating blueprints and/or engineering specifications for a real world object depicted by a virtual content object; performing one or more complex tasks; providing feedback based on one or more user interactions with virtual content depicted in the augmented reality environment; controlling one or more automated tasks; controlling one or more drones or nanorobots; directing a swarm of drones or nanorobots; and/or other actions or services that may be executed or performed by a non-human entity. In some implementations, the actions or services may comprise moving in space based on user input received (e.g., for a non-human entity comprising a drone), repairing a vessel (e.g., for a non-human entity comprising a remote manned or unmanned vehicle such as a submersible, explorer, or space vehicle); operating machinery (e.g., for a non-human entity configured to control the construction of a house); and/or other operations by devices connected to system 100. In some implementations, one or more actions or services may comprise predefined (or preprogrammed) options to modify virtual content. In some implementations, one or more actions or services may be related to interactive games. For example, one or more actions performed by a non-human entity may be an action within or in furtherance of an interactive game.

In some implementations, non-human interaction component 120 may be configured to identify one or more actions to be taken and/or services to be provided by one or more non-human entities before identifying the one or more non-human entities to perform the one or more actions and/or provide the one or more services. For example, non-human interaction component 120 may be configured to identify one or more actions or services based on user interaction with an augmented reality environment and use the identified one or more actions or services to identify a non-human entity to perform the one or more actions and/or provide the one or more services.

In some implementations, non-human interaction component 120 may be configured to identify one or more non-human entities based on user input before identifying one or more actions to be taken and/or services to be provided. For example, non-human interaction component 120 may be configured to identify a non-human entity to interact with based on user interaction with an augmented reality environment and use the identified non-human entity to identify one or more actions or services to be performed by the non-human entity. In some implementations, non-human interaction component 120 may be configured to determine one or more capabilities of an identified non-human entity based on non-human entity information for the identified non-human entity. Responsive to a determination that the identified non-human entity is not capable of performing one or more actions or providing one or more services defined by the user input, non-human interaction component 120 may be configured to cause a message to be provided to the user indicating that action or service may not be provided by the non-human entity. For example, the message may be provided to the user via a user interface generated by user interface component 118.

In some implementations, non-human interaction component 120 may be configured to identify one or more non-human entities to interact with, one or more actions to be executed, and/or one or more services to be provided based on user preferences and/or the user interaction history. For example, non-human entity information may include user preferences related to individual non-human entities and/or actions or services to be performed by an individual non-human entity, and a user interaction history comprising a record of prior user interactions with one or more non-human entities and the one or more actions and/or services performed by the non-human entities. In an exemplary implementation, non-human interaction component 120 may be configured to determine that a user prefers a first non-human entity over a second non-human entity based on user preferences included in the non-human entity information. Based on the foregoing determination, non-human interaction component 120 may be configured to cause instructions to be provided to the first non-human entity instead of the second non-human entity.

In various implementations, non-human interaction component 120 may be configured to identify information to be communicated to one or more non-human entities to enable the one or more non-human entities to execute the one or more actions and/or provide one or more services. For example, non-human interaction component 120 may be configured to determine that user input indicates a request to generate or construct a real-world object based on virtual content displayed in an augmented reality environment. Based on the determination that user input indicates a request to generate or construct a real-world object based on virtual content displayed in an augmented reality environment, non-human interaction component 120 may be configured to determine that virtual content information defining the virtual content must be provided to the non-human entity to enable the non-human entity to generate or construct a real-world object based on the virtual content.

In various implementations, non-human interaction component 120 may be configured to generate instructions for one or more non-human entities. For example, non-human interaction component 120 may be configured to generate instructions for a non-human entity based on identified actions and/or services to be provided by the non-human entity. The instructions generated for the non-human entity may cause the non-human entity to perform the identified actions and/or provide the identified services. In some implementations, the instructions for a non-human entity may include and/or be based on identified information that enables the non-human entity to execute one or more actions and/or provide one or more services. In various implementations, non-human interaction component 120 may be configured to generate instructions for a non-human entity based on communication requirements for that non-human entity. For example, non-human interaction component 120 may be configured to obtain non-human entity information for a non-human entity that indicates a predefined format (e.g., a predefined machine language) that is acceptable for communicating with that non-human entity.

In some implementations, non-human interaction component 120 may be configured to identify one or more actions to be taken and/or services to be provided by one or more non-human entities in real-time. In other words, instructions causing a non-human entity to perform one or more actions or provide one or more services may be provided automatically, causing the one or more actions or services to be performed in real-time. In some implementations, non-human interaction component 120 may be configured to identify one or more actions to be taken and/or services to be provided by a non-human entity at a later time. For example, user input indicating a set of actions by a non-human entity to solve a problem may be received, and only after user input is received indicating that the set of actions is complete, instructions causing a non-human entity to perform the set of actions may be provided to the non-human entity.

In some implementations, non-human interaction component 120 may be configured to generate instructions for one or more non-human entities that include a prompt for the one or more non-human entities. For example, non-human interaction component 120 may be configured to cause a non-human entity to provide feedback based on user interaction with a virtual content object. In some implementations, non-human interaction component 120 may be configured to generate instructions for a non-human entity that prompt the non-human entity to provide feedback. In some implementations, non-human interaction component 120 may be configured to cause a non-human entity to provide feedback based on user interaction with a virtual content object. For example, non-human interaction component 120 may be configured to generate and transmit instructions to cause a non-human entity to provide feedback based on user modification of a virtual content object. For example, instructions generated by non-human interaction component 120 may be configured to prompt a non-human entity to provide feedback indicating an updated specification for a virtual content object. The updated specification may be based on a request to modify the virtual content object and/or modifications already made to the virtual content object. The specification may comprise a blueprint or engineering specification for a real-world object depicted by the virtual content object.

In various implementations, a non-human entity interaction may comprise a series of communications and/or actions by a user and one or more non-human entities. In other words, a non-human entity interaction may comprise an iterative interaction in which concurrent, serial, and/or sequential instructions are provided to one or more non-human entities based on user interaction with an augmented reality environment. An iterative process may comprise a process for calculating a desired result and/or performing a given action to achieve a desired result by means of multiple operations. For example, an iterative process may be convergent, wherein the each operation of the multiple operations causes the desired result to become closer to being achieved. Based on a user interaction with an augmented reality environment, first instructions may be transmitted to one or more non-human entities. Based on the response and/or feedback of the one or more non-human entities, additional user interaction with virtual content in an augmented reality environment may cause one or more additional sets of instructions (i.e., second instructions and/or third instructions) to be provided to one or more non-human entities. In some implementations, a non-human entity interaction may comprise a series of instructions sent to multiple non-human entities. In an exemplary implementation, a first user interaction with an augmented reality environment may cause a first non-human entity comprising a 3-D printer to generate a patch. For example, the patch may comprise a component used in the repair of an real-world object. In the foregoing exemplary implementation, a second user interaction with an augmented reality environment may cause a second non-human entity comprising a drone (or a set of drones) to apply the patch made by the first non-human entity to the real-world object. In some implementations, the generation of the patch by the 3-D printer and the application of the patch by one or more drones may be caused to be performed based on the same user interaction with an augmented reality environment. In other words, a single user interaction with an augmented reality environment may cause multiple actions to be performed by one or more separate non-human entities.

For example, and referring to FIG. 2A, exemplary display 200 of an augmented reality environment is illustrated, in accordance with one or more implementations. Exemplary display 200 may comprise an image of virtual content 202 comprising a house. Based on user input received related to virtual content 202, non-human interaction component 120 may be configured to identify one or more actions or services indicated by the user input (e.g., generate or update a blueprint for a house that corresponds to virtual content 202), identify a non-human entity to perform the one or more actions or services, and cause instructions to be transmitted to the non-human entity to perform the identified one or more actions or services. For example, the identified non-human entity may generate or update a blueprint for a house that corresponds to virtual content 202 responsive to instructions generated and/or communicated by non-human interaction component 120.

In some implementations, one or more non-human entities may perform one or more calculations based on user input, virtual content information, and/or modifications to virtual content displayed in an augmented reality environment. For example, a non-human entity may be prompted to perform necessary calculations for a blueprint or engineering specification. In the foregoing exemplary implementation, a user viewing a virtual content object in an augmented reality environment depicting a house may make modifications to the house (e.g., make, relocate, or otherwise modify one or more design features of the house). For example, a user viewing a virtual content object in an augmented reality environment depicting a house may modify the orientation of the house with respect to the property by modifying the orientation of the virtual content object in the augmented reality environment. Based on the updated virtual content object, a non-human entity (such as a bot or virtual assistant) may provide feedback updating the specification of the virtual content object which may be sent to an architect or builder in the real world.

In an exemplary implementation, user input may be received comprising a request to construct all or a portion of a virtual content object displayed in an augmented reality environment. For example, a request to construct all or a portion of a virtual content object displayed in an augmented reality environment may be carried out by a three-dimensional (3D) printer. In some implementations, non-human interaction component 120 may be configured to generate and transmit instructions to prompt one or more non-human entities (e.g., a 3D printer and/or other non-human entity) to facilitate construction of an object in the real world based on a virtual content object. For example, responsive to instructions generated and/or provided via non-human interaction component 120, a non-human entity may automate the construction of an object in the real world by causing one or more external devices to physically construct the object based on the virtual content object.

In an exemplary implementation, user input may indicate a request involving one or more actions or services to be performed or provided by a 3D printer. For example, the user input may comprise a request for a 3D printer to generate and/or construct all or a portion of a virtual content object displayed in an augmented reality environment. Based on the virtual content object, non-human interaction component 120 may be configured to generate and transmit instructions to cause a non-human entity comprising a 3D printer to print polymer components necessary to build and/or repair an object depicted by a virtual content object. For example, non-human interaction component 120 may be configured to generate and transmit instructions to cause a non-human entity comprising a 3D printer to print components to serve as biological tissue components, such as a defective heart valve generated based on a virtual content object depicting a human heart and the defective heart valve. Instructions transmitted to a 3D printer to cause the 3D printer to generate all or a portion of a virtual content object may include at least a portion of virtual content information defining the virtual content object. Transmitting the instructions including at least a portion of the virtual content information may cause the 3D printer to generate a physical representation of the virtual content object. By interfacing with a 3D printer and/or other non-human entities, objects created in an augmented reality environment may be generating or constructed in the real world.

In an exemplary implementation, user input may be received comprising a request to modify an object depicted in an augmented reality environment. The object depicted in the augmented reality environment may comprise a visual representation of an object that exists in the real world. In other words, when displayed in the augmented reality environment, the object may comprise a virtual content object. The virtual content object may comprise a visual representation of an object that exists in the real world but is remote from the user viewing the virtual content object via a display device (e.g., display device 140). User interface component 118 may be configured to receive the user input comprising the request to modify the object via a user interface. In some implementations, the object that is to be modified may be identified based on user input selecting the virtual content object, one or more prior interactions with the virtual content object, and/or otherwise identified based on the user input received. Non-human interaction component 120 may be configured to identify one or more actions to be taken and/or services to be provided by one or more non-human entities based at least on the user input received. For example, the request to modify the object may comprise a request to modify the virtual content object (i.e., the image of the object displayed in the augmented reality environment) and/or a request to modify the object that exists in the real world based on modifications to the virtual content object.

In some implementations, non-human interaction component 120 may be configured to generate and transmit instructions to cause one or more non-human entities to perform a task based on user interaction with a virtual content object. For example, a non-human user may facilitate the execution of one or more complex tasks based on user interaction with a virtual content object in an augmented reality environment. In an exemplary implementation, a virtual content object may depict a patient's brain. By imaging the patient's brain, virtual content information defining at least virtual content depicting the patient's brain may be generated and caused to be displayed in an augmented reality environment via image generation component 114. In response to user interaction with the virtual content object in an augmented reality environment, non-human interaction component 120 may be configured to generate and transmit instructions to cause corresponding actions (i.e., surgical operations) to be performed in the real world via communication with one or more non-human entities configured to facilitate the corresponding actions. Complex tasks performed via communication with a non-human entity may comprise surgical operations, interactions with dangerous substances (e.g., diffusing a bomb), interactions in dangerous environments (e.g., at a nuclear reactor, underwater, in space, on the moon or Mars), mining operations, and/or other complex tasks.

In an exemplary implementation, virtual content displayed in an augmented reality environment may depict a manned or unmanned vehicle that is remote from the user and display device 140. For example, image generation component 116 may be configured to generate an image of virtual content depicting a submarine located at the bottom of the ocean, and display control component 116 may be configured to cause the image to be displayed in an augmented reality environment visible to a user via display device 140 as if the submarine were present within a field of view of the user. User interface component 118 may be configured to receive user input modifying the virtual content. For example, the submarine in the real world may include one or more holes that caused it to sink to the bottom of the ocean. The image of virtual content may be generated by 3D cameras affixed to unmanned submersibles investigating and/or salvaging the sunken submarine. The unmanned submersibles investigating and/or salvaging the sunken submarine may comprise non-human entities. In the augmented reality environment, a user may modify the virtual content depicting the sunken submarine to repair the one or more holes that caused it to sink. For example, user interface component 118 may be configured to receive user input comprising requests to modify the virtual content to repair the one or more holes depicted on the virtual content displayed in the augmented reality environment. Based on the user input, non-human interaction component 120 may be configured to identify one or more actions to be performed by the unmanned submersibles to repair the one or more holes. For example, non-human interaction component 120 may be configured to identify one or more actions to be performed by the unmanned submersibles to repair the one or more holes as the holes were repaired in the augmented reality environment. Based on the identified one or more actions, non-human interaction component 120 may be configured to generate one or more instructions that, when communicated to the unmanned submersibles by communication component 122, cause the unmanned submersibles to repair the one or more holes on the real-world submarine located at the bottom of the ocean. As such, non-human interaction component 120 may be configured to facilitate interaction with one or more non-human entities that are remote from a user and display device 140 based on user interaction with an augmented reality environment displayed via display device 140.

In various implementations, non-human interaction component 120 may be configured to generate and transmit instructions to cause non-human entities to generate virtual content objects in real-time. For example, non-human interaction component 120 may be configured to cause non-human entities equipped with 3D cameras and/or one or more other sensors to generate a virtual content object in real-time that may be viewed and interacted with by a user (e.g., to explore, diagnose emergencies, formulate and/or test possible solutions, make repairs, and/or provide feedback related to ongoing construction). In other words, non-human interaction component 120 may be configured to cause one or more non-human entities to generate virtual content information defining virtual content that may be displayed in the augmented reality environment.

In various implementations, one or more non-human entities associated with system 100 may comprise one or more drones. Notably, drones may be one or more different sizes (i.e., big or small) and be able to perform one or more of various functions, including flying, swimming, driving, navigating, and/or one or more other functions. By interacting with an augmented reality environment, a user may control one or more drones. For example, a user may control a set of drones (e.g., a swarm of drones) by interacting with controls displayed via a user interface generating by user interface component 118. A swarm of drones may comprise a set of drones operating (or controlled) in unison. In response to instructions generated by non-human interaction component 120, the swarm of drones may be instructed to engage in a synchronized behavior that is based on user input received. For example, the swarm of drones may be controlled to effect a repair, build a complex structure, attack an enemy, put out a fire, provide security or defense, and/or perform one or more other coordinated actions based on user input received via an augmented reality environment. The swarm of drones may be depicted in an augmented reality environment as and/or correspond to one or more virtual content items. A user may interact with the one or more virtual content items to cause one or more drones to operate at a remote location. For example, a user may control the one or more drones from a remote location while the drones operate based on user input in an area where it is dangerous, impractical, compact, and/or otherwise impossible for humans to operate. Drones may be controlled remotely via the methods described herein to perform any number of tasks. For example, a user may utilize controls depicted in an augmented reality environment to instruct one or more drones to focus cameras, weapons, fire-fighting apparatus, and/or other component affixed to the drone on a particular point or a sequential series of points in a virtual image (e.g., to focus on a specific window in a building, a face in a crowd, on a cave entrance or bunker, inside a biological entity, a sand trap or putting green, and/or other particular points). These focused images may be provided to third parties that may not be able to travel as efficiently to the particular points themselves (such as fire fighters, soldiers, surgeons, golfers, TV crews, and/or other third parties).

In various implementations, one or more non-human entities associated with system 100 may comprise nanorobots. A nanorobot may comprise a machine made from individual atoms or molecules that is designed to perform a small and specific job. For example, a nanorobot may be designed to assist in or perform surgical operations (e.g., removing brain tumors or repairing damaged tissue); aid in the manufacture, assembly, and maintenance of sophisticated devices, machines, or circuits; interact with graphene structures; perform molecular inspection of nuclear reactor containment vessels; serve as the functional equivalent of leukocytes and/or antibodies in living entities; perform the targeted delivery of drugs to infections (such as cancer cells); removing blood dots and unblocking arteries; and/or other applications now known or future developed. Nanorobots may be controlled remotely via the methods described herein to perform any number of tasks, including the tasks identified above. For example, a user may utilize controls depicted in an augmented reality environment to instruct one or more nanorobots to perform targeted drug delivery, interact with a graphene structure, unblock an artery, and/or perform one or more other tasks. A single nanorobot, multiple nanorobots, and/or a set of nanorobots (e.g., a swarm of nanorobots) may be controlled remotely via the methods described herein to perform any number of tasks. A swarm of nanorobots may comprise a set of nanorobots operating (or controlled) in unison. For example, via user interaction with an augmented reality environment, a user may control a swarm of nanorobots to perform brain surgery on a patient in a medical facility.

In an exemplary implementation, system 100 may be associated with one or more non-human entities configured to assist medical professionals. For example, system 100 may be associated with a software agent (such as a virtual assistant), an artificial intelligence-powered device, and/or other electronic device or component configured to perform specialized tasks or services based on user input. For example, user input received via user interface component 118 may comprise an indication and/or visual identification of symptoms for a patient. Non-human interaction component 120 may be configured to interface with one or more non-human entities designed to assist in medical diagnoses and provide instructions to supply a supplemental diagnosis. For example, the instructions may include an indication and/or visual identification of symptoms of the patient as they were seen in the augmented reality environment via display device 140. Providing the instructions and information to the non-human entity may cause the non-human entity to access a medical database and utilize artificial intelligence to supply a supplemental diagnosis, provide a treatment plan, monitor patient condition via periodic user input, and/or document information received and generated to maintain a supplemental medical record.

In some implementations, virtual content depicted in an augmented reality environment may comprise a visual representation of a real-world physical object, entity, individual, or appendage, wherein human sexual intercourse and/or one or more other sexual activities may be simulated in the real-world based on user interaction with the visual representation in the augmented reality environment. In an exemplary implementation, virtual content depicted in an augmented reality environment may be associated with a smart device non-human entity designed to simulate human sexual intercourse and/or one or more other sexual activities in the real-world based on user interaction with the virtual content. For example, the smart device may be penetrative or extractive. Based on user interaction with the augmented reality environment, non-human interaction component 120 may be configured to generate instructions to be provided to the smart device non-human entity (i.e., by communication component 122) that cause one or more actions to be performed or executed by the smart device non-human entity that are designed to simulate human sexual intercourse and/or one or more other sexual activities.

In some implementations, virtual content depicted in an augmented reality environment may comprise a visual representation of one or more tools. For example, tools depicted in an augmented reality environment may comprise miniature tools and/or other tools used by scientists, surgeons, engineers, and/or other individuals in the real-world. In an exemplary implementation, virtual content depicted in an augmented reality environment may comprise a visual representation of optical tweezers. Optical tweezers may comprise an instrument that utilizes a focused laser beam to provide an attractive or repulsive force to physically hold and move microscopic objects. Based on user interaction with the virtual content depicting the optical tweezers in an augmented reality environment, the optical tweezers may be utilized in the real-world based on instructions generated and communicated to a non-human entity that cause the non-human entity to perform one or more actions with the optical tweezers based on the user interaction.

Communication component 122 may be configured to facilitate communication with one or more non-human entities. In various implementations, communication component 122 may be configured cause instructions to be provided to one or more non-human entities. For example, communication component 122 may be configured to transmit instructions to non-human entities via a network. In various implementations, communication component 122 may be configured to obtain instructions generated by non-human interaction component 120 and cause the instructions to be transmitted to the appropriate non-human entity. In some implementations, the instructions may include information required by the non-human entity and/or necessary to perform one or more actions and/or provide one or more services. In some implementations, communication component 122 may be configured to receive responses from non-human entities. For example, communication component 122 may be configured to receive a response from the non-human entity, wherein the response includes a message and instructions to provide the message to the user. In response to receipt of the message from the non-human entity, communication component 122 may be configured to cause the message to be communicated to the user. For example, communication component 122 may be configured to cause the message to be communicated to the user via a display device (e.g., display device 140).

Electronic storage 130 may include electronic storage media that electronically stores information. The electronic storage media of electronic storage 130 may be provided integrally (i.e., substantially non-removable) with one or more components of system 100 and/or removable storage that is connectable to one or more components of system 100 via, for example, a port (e.g., a USB port, a Firewire port, etc.) or a drive (e.g., a disk drive, etc.). Electronic storage 130 may include one or more of optically readable storage media (e.g., optical disks, etc.), magnetically readable storage media (e.g., magnetic tape, magnetic hard drive, floppy drive, etc.), electrical charge-based storage media (e.g., EPROM, EEPROM, RAM, etc.), solid-state storage media (e.g., flash drive, etc.), and/or other electronically readable storage media. Electronic storage 130 may be a separate component within system 100, or electronic storage 130 may be provided integrally with one or more other components of system 100 (e.g., a user device, processor 110, or display device 140). Although electronic storage 130 is shown in FIG. 1 as a single entity, this is for illustrative purposes only. In some implementations, electronic storage 130 may comprise multiple storage units. These storage units may be physically located within the same device, or electronic storage 130 may represent storage functionality of multiple devices operating in coordination.

Electronic storage 130 may store software algorithms, information determined by processor 110, information received remotely, and/or other information that enables system 100 to function properly. For example, electronic storage 130 may store virtual content information, an indication of virtual content stored and/or accessible by the system, an indication of non-human entities associated with the system, non-human entity information for each non-human entity associated with the system, a map of capabilities of non-human entities associated with the system, images generated by image generation component 114, sensor information (e.g., orientation information), device information, location information, and/or other information obtained, generated, and/or utilized by system 100.

Display device 140 may be configured to present virtual content in an augmented reality environment. In various implementations, display device 140 may be configured to generate and provide images of virtual content superimposed over physical objects and/or physical surroundings visible within a field of view of the user as if the images of the virtual content were present in the real world. In some implementations, display device 140 may be configured to generate light and provide the light to an eye of a user such that the light forms images of the virtual content configured to be perceived in the augmented reality environment as if it were present in the real world. Display device 140 may include one or more of a display, one or more sensors, and/or other components. Presentation of virtual content via a display of display device 140 may be facilitated by control signals communicated to display device 140. For example, display control component 116 may be configured to communicate one or more control signals to display device 140. In some implementations, display device 140 may be configured to present content individually to each eye of a user as stereoscopic pairs.

Display device 140 may comprise any device capable of displaying a real-time view of a physical, real-world environment while superimposing images of virtual content over the real-time view of the physical, real-world environment. As such, display device 140 may comprise any device that includes and/or is communicatively coupled to an image capturing device (e.g., a camera and/or any other device that includes an imaging sensor) that may be used to capture a view of the real-world environment. For example, display device 140 may comprise and/or be communicatively coupled to a depth camera, a stereoscopic camera, and/or one or more other cameras that may be used to capture one or more images of a user or a physical environment.

In various implementations, display device 140 may comprise a smartphone, a tablet, a computer, a wearable device (e.g., a headset, a visor, glasses, contact lenses, and/or any other wearable device), a monitor, a projector, and/or any other device configured to present views of virtual content in an augmented reality environment. In various implementations, display device 140 may include or be associated with one or more speakers for playing one or more sounds associated with a virtual content object. In some implementations, display device 140 may be arranged on, and/or may comprise part of, a headset (not shown in FIG. 1). When headset is installed on a user's head, the user's gaze may be directed towards display device 140 (or at least a display of display device 140) to view content presented by display device 140.

A display of display device 140 may include one or more of screen, a set of screens, a touchscreen, a monitor, a headset (e.g., a head-mounted display, glasses, goggles), contact lenses, and/or other displays. In some implementations, a display may include one or more of a transparent, semi-transparent, reflective, and/or semi-reflective display component, such as a visor, glasses, and/or contact lenses. Images of virtual content may be presented on the display component such that the user may view the images presented on the display component as well as the real-world through the display component. The virtual content may be perceived as being present in the real world. Such a configuration may provide an interactive space comprising an augmented reality environment. By way of non-limiting illustration, display device 140 may comprise an AR headset.

Individual sensors of display device 140 may be configured to generate output signals. An individual sensor may include an orientation sensor, and/or other sensors (e.g., imaging sensor 150). An orientation sensor of display device 140 may be configured to generate output signals conveying orientation information and/or other information. Orientation information derived from output signals of an orientation sensor may define an orientation of display device 140. In some implementations, orientation of display device 140 may refer to one or more of a pitch angle, a roll angle, a yaw angle, and/or other measurements. An orientation sensor may include an inertial measurement unit (IMU) such as one or more of an accelerometer, a gyroscope, a magnetometer, Inclinometers, and/or other devices. In various implementations, the orientation of display device 140 may be communicated to image generation component 114 to generate and/or update images of a virtual content object to be viewed via display device 140. Imaging sensor 150 may be configured to generate output signals conveying a series of images depicting a field of view of the user. In various implementations, imaging sensor 150 may be physically located within display device 140, physically located separate from display device 140, and/or within any of the other components of system 150. For example, imaging sensor 150 may be physically located within a depth sensing camera communicatively coupled to display device 140 and/or one or more other components of system 100.

System 100 may include one or more devices configured to or capable of providing haptic features via tactile output. For example, a user device, display device 140, and/or one or more other components of system 100 may be configured to vibrate based on one or more parameters defining haptic features of virtual content. A haptic feature may comprise one or more effects associated with virtual content observed haptically. For example, effects observed haptically may comprise one or more of a vibration, a motion, a temperature, and/or other haptic effects observed via tactile output. Haptic features may be static or dynamic, and may be haptically observed at a time, over a period of time, at a location, and/or over a range of locations. Virtual content information defining virtual content may define one or more triggers associated with one or more haptic features of the virtual content.

Implementations of the disclosure may be made in hardware, firmware, software, or any suitable combination thereof. Aspects of the disclosure may be implemented as instructions stored on a machine-readable medium, which may be read and executed by one or more processors. A machine-readable medium may include any mechanism for storing or transmitting information in a form readable by a machine (e.g., a computing device). For example, a tangible computer readable storage medium may include read only memory, random access memory, magnetic disk storage media, optical storage media, flash memory devices, and others, and a machine-readable transmission media may include forms of propagated signals, such as carrier waves, infrared signals, digital signals, and others. Firmware, software, routines, or instructions may be described herein in terms of specific exemplary aspects and implementations of the disclosure, and performing certain actions.

Although processor 110, electronic storage 130, display device 140, and imaging sensor 150 are shown to be connected to interface 102 in FIG. 1, any communication medium may be used to facilitate interaction between any components of system 100. One or more components of system 100 may communicate with each other through hard-wired communication, wireless communication, or both. For example, one or more components of system 100 may communicate with each other through a network. For example, processor 110 may wirelessly communicate with electronic storage 130. By way of non-limiting example, wireless communication may include one or more of the Internet, radio communication, Bluetooth communication, Bluetooth Low Energy (BLE) communication, Wi-Fi communication, cellular communication, infrared communication, or other wireless communication. Other types of communications are contemplated by the present disclosure.

Although processor 110 is illustrated in FIG. 1 as a single component, this is for illustrative purposes only. In some implementations, processor 110 may comprise multiple processing units. These processing units may be physically located within the same device, or processor 110 may represent processing functionality of multiple devices operating in coordination. For example, processor 110 may be located within a user device, display device 140, and/or other components of system 100. In some implementations, processor 110 may be remote from a user device, display device 140, and/or other components of system 100. Processor 110 may be configured to execute one or more components by software; hardware; firmware; some combination of software, hardware, and/or firmware; and/or other mechanisms for configuring processing capabilities on processor 110.

Furthermore, it should be appreciated that although the various instructions are illustrated in FIG. 1 as being co-located within a single processing unit, in implementations in processor(s) 110 include multiple processing units, one or more instructions may be executed remotely from the other instructions.

The description of the functionality provided by the different computer-readable instructions described herein is for illustrative purposes, and is not intended to be limiting, as any of instructions may provide more or less functionality than is described. For example, one or more of the instructions may be eliminated, and some or all of its functionality may be provided by other ones of the instructions. As another example, processor(s) 110 may be programmed by one or more additional instructions that may perform some or all of the functionality attributed herein to one of the computer-readable instructions.

Exemplary Flowcharts of Processes

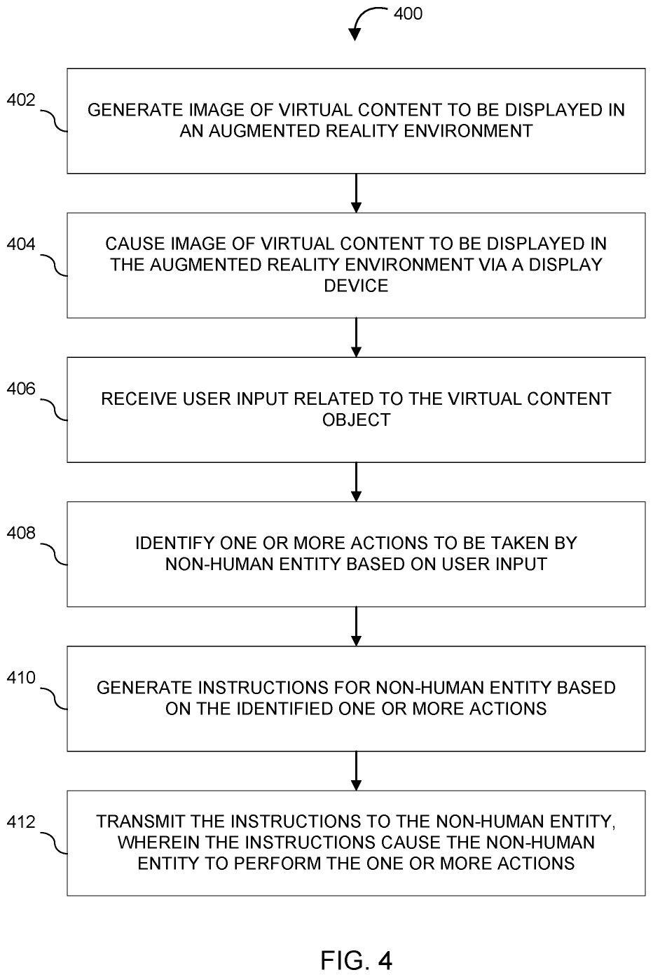

FIG. 4 illustrates a method 400 for interfacing with one or more non-human entities based on user interaction with an augmented reality environment, in accordance with one or more implementations. The operations of method 400 presented below are intended to be illustrative and, as such, should not be viewed as limiting. In some implementations, method 400 may be accomplished with one or more additional operations not described, and/or without one or more of the operations discussed. In some implementations, two or more of the operations may occur substantially simultaneously. The described operations may be accomplished using some or all of the system components described in detail above.

In some implementations, method 400 may be implemented in one or more processing devices (e.g., a digital processor, an analog processor, a digital circuit designed to process information, a central processing unit, a graphics processing unit, a microcontroller, an analog circuit designed to process information, a state machine, and/or other mechanisms for electronically processing information). The one or more processing devices may include one or more devices executing some or all of the operations of method 400 in response to instructions stored electronically on one or more electronic storage mediums. The one or more processing devices may include one or more devices configured through hardware, firmware, and/or software to be specifically designed for execution of one or more of the operations of method 400.

In an operation 402, method 400 may include generating an image of a virtual content object to be displayed in an augmented reality environment. The image of the virtual content object may be generated based at least on the user's field of view and virtual content information defining at least the virtual content object and a reference frame of the virtual content object. In various implementations, the image of the virtual content object may comprise a virtual representation of a real world physical object that is remote from a user. In some implementations, operation 402 may be performed by a processor component the same as or similar to image generation component 114 (shown in FIG. 1 and described herein).

In an operation 404, method 400 may include causing the image to be displayed in the augmented reality environment via a display device. For example, the image may be displayed via a display device configured to generate and provide images of virtual content superimposed over physical objects and/or physical surroundings visible within a field of view of a user as if the images of the virtual content were present in the real world. An augmented reality environment may comprise a simulated environment that includes the visual synthesis and/or combination of both (i) visible physical objects and/or physical surroundings, and (ii) visual virtual content presented in conjunction with the visible physical objects and/or physical surroundings to visually augment the visible physical objects and/or physical surroundings. In some implementations, operation 404 may be performed by a processor component the same as or similar to display control component 116 (shown in FIG. 1 and described herein).

In an operation 406, method 400 may include receiving user input related to the virtual content object. For example, the user input related to the virtual content object may comprise a request to modify the virtual content object, and/or perform one or more actions or provide one or more services related to the virtual content object. User input may comprise physical input received via a user device, voice input, gesture-based input, input based on movement of the display device, input based on user eye movement, input received via a brain-computer interface (BCI), and/or one or more other types of user input. In some implementations, operation 406 may be performed by a processor component the same as or similar to user interface component 118 (shown in FIG. 1 and described herein).

In an operation 408, method 400 may include identifying one or more actions to be taken by the non-human entity based on the user input. For example, a non-human entity may comprise a smart device, a software agent (such as a virtual assistant), a connected device, an Internet of Things (IoT) device, an artificial intelligence-powered device, and/or other electronic device or component configured to perform tasks or services based on user input. In various implementations, non-human entity information for each of a set of non-human entities associated with the system may be electronically stored. The non-human entity information may describe at least one or more capabilities of each of the set of non-human entities. In some implementations, the non-human entity information may also specify an association between each action capable of being performed by the set of non-human entities and a set of predefined user inputs. The one or more actions to be taken by the non-human entity may be identified based on the user input, the capabilities of each of the set of non-human entities, and/or the stored association between each action capable of being performed by the set of non-human entities and the set of predefined user inputs. In some implementations, operation 408 may be performed by a processor component the same as or similar to non-human interaction component 120 (shown in FIG. 1 and described herein).

In an operation 410, method 400 may include generating instructions for the non-human entity based on the identified one or more actions. The instructions generated for the non-human entity may cause the non-human entity to perform the identified actions and/or provide one or more identified services. For example, the instructions may cause the non-human entity to perform the identified one or more actions on the real world physical object. For example, responsive to user input comprising a request to modify a virtual content object, instructions may be automatically generated that cause a non-human entity to modify a real world physical object corresponding the virtual content object based on the user input. In some implementations, the instructions for a non-human entity may be generated based on communication requirements for that non-human entity. For example, non-human entity information for that non-human entity may be obtained that indicates a predefined format (e.g., a predefined machine language) that is acceptable for communicating with that non-human entity. The instructions may be generated in the predefined format for that specific non-human entity based on the non-human entity information. In some implementations, operation 410 may be performed by a processor component the same as or similar to non-human interaction component 120 (shown in FIG. 1 and described herein).

In an operation 412, method 400 may include causing the instructions to be transmitted to the non-human entity. The instructions may include information required to interface with the non-human entity and/or information that is necessary to perform the one or more actions and/or provide the one or more services. In some implementations, the non-human entity may respond to the instructions provided. For example, a response may be received from the non-human entity that comprises a message and instructions to provide the message to the user. Responsive to receipt of the message from the non-human entity, the message may be communicated to the user via a display device. In some implementations, operation 412 may be performed by a processor component the same as or similar to communication component 122 (shown in FIG. 1 and described herein).

For purposes of explanation, numerous specific details are set forth in order to provide a thorough understanding of the description. It will be apparent, however, to one skilled in the art that implementations of the disclosure can be practiced without these specific details. In some instances, modules, structures, processes, features, and devices are shown in block diagram form in order to avoid obscuring the description. In other instances, functional block diagrams and flow diagrams are shown to represent data and logic flows. The components of block diagrams and flow diagrams (e.g., modules, blocks, structures, devices, features, etc.) may be variously combined, separated, removed, reordered, and replaced in a manner other than as expressly described and depicted herein.

Reference in this specification to “one implementation”, “an implementation”, “some implementations”, “various implementations”, “certain implementations”, “other implementations”, “one series of implementations”, or the like means that a particular feature, design, structure, or characteristic described in connection with the implementation is included in at least one implementation of the disclosure. The appearances of, for example, the phrase “in one implementation” or “in an implementation” in various places in the specification are not necessarily all referring to the same implementation, nor are separate or alternative implementations mutually exclusive of other implementations. Moreover, whether or not there is express reference to an “implementation” or the like, various features are described, which may be variously combined and included in some implementations, but also variously omitted in other implementations. Similarly, various features are described that may be preferences or requirements for some implementations, but not other implementations.

The language used herein has been principally selected for readability and instructional purposes, and it may not have been selected to delineate or circumscribe the inventive subject matter. Other implementations, uses and advantages of the invention will be apparent to those skilled in the art from consideration of the specification and practice of the invention disclosed herein. The specification should be considered exemplary only, and the scope of the invention is accordingly intended to be limited only by the following claims.

1. A system configured to interface with a remote non-human entity based on user interaction with an augmented reality environment, the system comprising:
a display device configured to generate and provide images of virtual content superimposed over physical objects and/or physical surroundings visible within a field of view of the user as if the images of the virtual content were present in the real-world, wherein the display device is physically discrete and separate from the remote non-human entity, wherein the remote non-human entity is outside immediate physical presence of the user, wherein the remote non-human entity is a tangible entity; and
one or more physical computer processors configured by computer readable instructions to:
generate an image of a virtual content object to be displayed in the augmented reality environment, wherein the image of the virtual content object comprises a virtual representation of a real-world physical object that is outside immediate physical presence of the user, wherein the remote non-human entity is physically discrete and separate from the real-world physical object;
cause the image to be displayed in the augmented reality environment via the display device, wherein the augmented reality environment includes (i) the physical objects and/or the physical surroundings visible within the field of view of the user and (ii) images of virtual content presented in conjunction with the physical objects and/or the physical surroundings, the virtual content comprising at least the virtual content object;
receive user input related to the virtual content object;
identify one or more actions to be taken and performed by the remote non-human entity based on the user input, wherein the one or more actions cause the remote non-human entity to physically manipulate the real-world physical object;
generate instructions for the remote non-human entity based on the identified one or more actions, wherein the instructions cause the remote non-human entity to perform the identified one or more actions on the real-world physical object; and
cause the instructions to be transmitted to the remote non-human entity.

2. The system of claim 1, wherein the remote non-human entity comprises a smart device, a software agent, or an artificial intelligence-powered device.

3. The system of claim 1, wherein the user input may comprise physical input received via a user device, voice input, gesture-based input, input based on movement of the display device, input based on user eye movement, or input received via a brain-computer interface.

4. The system of claim 1, wherein the one or more processors are further configured to:
receive a response from the remote non-human entity, wherein the response includes a message and instructions to provide the message to the user; and
cause the message to be communicated to the user via the display device.

5. The system of claim 1, wherein the one or more processors are further configured to:
electronically store non-human entity information for each of a set of non-human entities, the set of non-human entities including at least the remote non-human entity;
obtain the non-human entity information, wherein the non-human entity information describes one or more capabilities of each of the set of non-human entities, the one or more capabilities comprising one or more actions each of the set of non-human entities are able to perform; and
responsive to receipt of the user input, identify at least one of the set of non-human entities to transmit instructions based on the user input and the one or more capabilities of each of the set of non-human entities, wherein the at least one of the set of non-human entities includes the remote non-human entity.

6. The system of claim 5, wherein the non-human entity information further specifies an association between each of the one or more actions and a set of predefined user inputs, wherein the one or more actions to be taken by the remote non-human entity based on the user input are identified based on the non-human entity information.

7. The system of claim 5, wherein the non-human entity information includes an indication of a predefined format for communicating with the remote non-human entity, wherein the one or more processors are further configured to:
generate the instructions for the remote non-human entity based on the predefined format.

8. (canceled)

9. The system of claim 1, wherein the real world physical object depicted by the virtual content object comprises a house.

10. The system of claim 1, wherein the remote non-human entity comprises a 3-D printer and the instructions comprise at least a portion of virtual content information defining the virtual content object, wherein transmitting the instructions to the 3-D printer causes the 3-D printer to generate a physical representation of the virtual content object.

11. The system of claim 1, wherein the remote non-human entity comprises a drone, a nanorobot, a swarm of drones, or a swarm of nanorobots.

12. The system of claim 1, wherein the real-world physical object comprises a remote manned or unmanned vehicle.

13. A method for interfacing with a remote non-human entity based on user interaction with an augmented reality environment, the method comprising:
generating an image of a virtual content object to be displayed in the augmented reality environment, wherein the image of the virtual content object comprises a virtual representation of a real-world physical object that is outside immediate physical presence of a user, wherein the remote non-human entity is outside immediate physical presence of the user, wherein the remote non-human entity is a tangible entity that is physically discrete and separate from the real-world physical object;
causing the image to be displayed in the augmented reality environment via a display device that is physically discrete and separate from the remote non-human entity, wherein the augmented reality environment includes (i) physical objects and/or physical surroundings visible within a field of view of a user and (ii) images of virtual content presented in conjunction with the physical objects and/or the physical surroundings, the virtual content comprising at least the virtual content object;
receiving user input related to the virtual content object;
identifying one or more actions to be taken by the remote non-human entity based on the user input, wherein the one or more actions cause the remote non-human entity to physically manipulate the real-world physical object;
generating instructions for the remote non-human entity based on the identified one or more actions, wherein the instructions cause the remote non-human entity to perform the identified one or more actions on the real-world physical object; and
causing the instructions to be transmitted to the remote non-human entity.

14. The method of claim 13, wherein the remote non-human entity comprises a smart device, a software agent, or an artificial intelligence-powered device.

15. The method of claim 13, wherein the user input may comprise physical input received via a user device, voice input, gesture-based input, input based on movement of the display device, input based on user eye movement, or input received via a brain-computer interface.

16. The method of claim 13, the method further comprising:
receiving a response from the remote non-human entity, wherein the response includes a message and instructions to provide the message to the user; and
causing the message to be communicated to the user via the display device.

17. The method of claim 13, the method further comprising:
electronically storing non-human entity information for each of a set of non-human entities, the set of non-human entities including at least the remote non-human entity;
obtaining the non-human entity information, wherein the non-human entity information describes one or more capabilities of each of the set of non-human entities, the one or more capabilities comprising one or more actions each of the set of non-human entities are able to perform; and
responsive to receipt of the user input, identifying at least one of the set of non-human entities to transmit instructions based on the user input and the one or more capabilities of each of the set of non-human entities, wherein the at least one of the set of non-human entities includes the remote non-human entity.

18. The method of claim 17, wherein the non-human entity information further specifies an association between each of the one or more actions and a set of predefined user inputs, wherein the one or more actions to be taken by the remote non-human entity based on the user input are identified based on the non-human entity information.

19. The method of claim 17, wherein the non-human entity information includes an indication of a predefined format for communicating with the remote non-human entity, the method further comprising:
generating the instructions for the remote non-human entity based on the predefined format.

20. (canceled)

21. The method of claim 13, wherein the real world physical object depicted by the virtual content object comprises a house.

22. The method of claim 13, wherein the remote non-human entity comprises a 3-D printer and the instructions comprise at least a portion of virtual content information defining the virtual content object, wherein transmitting the instructions to the 3-D printer causes the 3-D printer to generate a physical representation of the virtual content object.

23. The method of claim 13, wherein the remote non-human entity comprises a drone, a nanorobot, a swarm of drones, or a swarm of nanorobots.

24. The method of claim 13, wherein the real-world physical object comprises a remote manned or unmanned vehicle.
